(19) United States
(12) Patent Application Publication
(10) Pub. No.: US 2025/0332053 A1
(43) Pub. Date: Oct. 30, 2025

(54) MEDICAL DEVICE AND SYSTEM FOR THERAPEUTIC DORSIFLEXION

(71) Applicant: THE TRUSTEES OF THE UNIVERSITY OF PENNSYLVANIA, Philadelphia, PA (US)

(72) Inventors: John D. Welsh, Philadelphia, PA (US); Mark L. Kahn, Bryn Mawr, PA (US)

(73) Assignee: THE TRUSTEES OF THE UNIVERSITY OF PENNSYLVANIA, Philadelphia, PA (US)

(21) Appl. No.: 19/191,795

(22) Filed: Apr. 28, 2025

Related U.S. Application Data
(63) Continuation-in-part of application No. 17/095,370, filed on Nov. 11, 2020.
Application No. 17/095,370 is a continuation of application No. PCT/US2019/032399, filed on May 15, 2019.
(60) Provisional application No. 62/671,905, filed on May 15, 2018.

(51) Int. Cl. A61H 1/02

(52) U.S. Cl. CPC A61H 1/0266; A61H 2201/0103; A61H 2201/1238; A61H 2201/1642; A61H 2201/165; A61H 2201/5007; A61H 2201/5056; A61H 2201/5071; A61H 2230/60

(57) ABSTRACT

The presently disclosed subject matter provides devices and systems for therapeutic foot dorsiflexion. Profound immobility, particularly during critical illness, leads to the onset of numerous physical issues. Many occur in the foot/ankle axis resulting in reduced ankle range of motion, ankle contractures, foot drop, and a loss of the ability to stand or ambulate. The disclosed subject matter provides an automated system capable of delivering therapeutic dorsiflexion by automatically adapting the degree of foot dorsiflexion to accommodate the patient's ankle range of motion.

### CROSS-REFERENCE TO RELATED APPLICATIONS

This application is a continuation in part of U.S. application Ser. No. 17/095,370, filed Nov. 11, 2020, which is a continuation of International Patent Application No. PCT/US2019/032399, filed May 15, 2019, which claims priority from U.S. Provisional Patent No. 62/671,905, filed May 15, 2018, which are each incorporated by reference herein and from which priority is claimed.

### STATEMENT OF GOVERNMENT INTEREST

This invention was made with government support under National Institute of Health grants R01HL121650, P01HL120846, R01HL120872, T32HL07439, RO1 HL126920, and ROIHL073402 awarded by the National Institute of Health. The government has certain rights in the invention.

### BACKGROUND

Critically ill and hospitalized patients are often profoundly immobile during their acute illness and recovery period. The nature of their illness and prolonged immobility lead to physical degradation and complications. Physical complications arise at high incidence in patients who have been hospitalized for extended periods of time. A common complication in immobile patients is reduced ankle range of motion (ROM), which can impede ambulation, increase fall risk, and lead to ankle contracture and foot drop causing long term disability and costly rehabilitation. Reduced ankle mobility requires mitigation to prevent contracture onset and to allow safe engagement of the patient in additional therapy and rehabilitation, such as standing and walking. However, in the critical care and in-patient hospital setting there is limited access to physical therapy that is often restricted due to limitations in clinician availability, cost of treatment, and complexity of the care environment.

The standard treatment for reduced ankle ROM is passive stretching of the ankle through a full range of motion to stimulate increased calf muscle flexibility and reduce joint stiffness. Static bracing and dynamic casting can also be used during periods between stretching treatments. However, static bracing is effective for maintaining the braced foot position and ROM, it has limited efficacy at increasing ROM and is suboptimal compared to full range of motion stretching. Dynamic casting can be used to increase ROM but requires weeks of casting and recasting the foot in increasingly stretched positions and can be uncomfortable for patients. There is a need for passive stretch therapy that stimulates the calf muscle and moves the ankle through a full ROM in a high volume treatment program that does not disrupt clinical care.

A key challenge in using bracing or casting is that ankle range of motion changes chronically as a result of therapy and duration of immobility, and also acutely during a stretching session. Therefore, stretching devices that do not continuously monitor and adjust the stretch therapy fail to fully stretch the calf muscles and joint and provide sub-optimal therapy. To best provide therapy that stimulates calf muscles and ankle joints there needs to be constant monitoring of the patient's range of motion and the therapy modified to induce a full stretch of the joint.

### SUMMARY

The presently disclosed subject matter provides systems for stretching a calf muscle and/or inducing a calf muscle stretch reflex in an immobile person through a boot configured to be worn on a foot of the immobile person. In certain embodiments, the system includes a wearable boot comprising a substantially rigid frame and an inflation bladder disposed between the rigid frame and the foot of the immobile person, where the wearable boot is configured to admit the foot of the immobile person and to flex a top region of the foot about 15° to about 40° dorsally when the inflation bladder is inflated to a set pressure. The system also includes a head unit, coupled to the inflation bladder and configured to provide compressed air to the inflation bladder to a set pressure. A pressure sensor can be configured to detect the internal pressure of the inflation bladder, and a processor arrangement can cause the head unit to provide compressed air to the inflation bladder and monitor the internal pressure of the inflation bladder during inflation.

In certain embodiments, the processor can control one or more parameters of inflation. In certain embodiments, the inflation occurs in a time interval of about 0.25 seconds to about 0.5 seconds. In certain embodiments, the inflation causes rapid flexion which induces a calf muscle stretch reflex thereby generating calf muscular contraction in the immobile person.

In certain embodiments, the head unit further comprises an air compressor, a compressed air tank, a valve adapted to regulate the release of the compressed air from the compressed air tank to the inflation bladder through the opening of the valve. The pressure sensor can detect the pressure of the inflation bladder. The processor arrangement can, control one or more parameters of inflation.

In certain embodiments, the patient's ankle range of motion (ROM) is determined from the peak internal pressure of the inflation bladder during a calibration cycle. The calibration cycle can include an inflation, a hold, and a deflation cycle. The processor can monitor the peak internal pressure of the inflation bladder during the calibration cycle. In certain embodiments, the one or more parameters of inflation comprise tank pressure and valve opening time. In certain embodiments, the one or more parameters of inflation are adjusted by an internal algorithm within the processor to inflate the inflation bladder to a set pressure during an inflation cycle to accommodate the patient's ROM.

In certain embodiments, the rigid frame of the wearable boot is substantially covered in fabric, foam, gel padding, or air-filled padding which is configured to secure the foot of the immobile person within the boot and elevating the heel to reduce friction forces while allowing the foot to flex dorsally.

In certain embodiments, the rapid flexion induced by the system triggers muscle contractions through a spinal reflex. In certain embodiments, the calf muscle contraction produces an electromyograph reading (EMG) of at least about 0.5 mV.

In certain embodiments, the head unit includes a control board adapted to initiate inflation of the inflation bladder and control parameters of inflation. The head unit can also include a solenoid valve, adapted to regulate the release of the compressed air from the compressed air tank to the inflation bladder through the opening of the valve for a set time. One or more pressure sensors can be used to monitor air pressure of the compressed air tank and restore the air pressure to a set level. At least one pressure sensor can monitor air pressure within the inflation bladder.

In certain embodiments, the control board is adapted to restore the air pressure of the compressed air tank to a set level, and open the solenoid valve for a set time. In certain embodiments, the compressed air tank is filled to a pressure of about 5 psi to about 25 psi and varied to alter the degree and speed of bladder inflation. In certain embodiments, the solenoid valve is opened for a time period ranging from about 0.25 seconds to about 1.00 second. In certain embodiments, the solenoid valve is opened for a time period ranging from about 1.00 second to about 10 seconds. In certain embodiments, the time to peak flexion is decreased by increasing the set level of the air pressure in the compressed air tank, and the time to peak flexion is decreased by increasing the set level of air pressure in the compressed air tank; and the flexion duration is increased by increasing the solenoid valve opening time, and the duration of foot flexion is decreased by decreasing the solenoid valve opening time. In certain embodiments, an algorithm in the control board monitors the internal pressure of the inflation bladder and modifies the set level of air pressure in the compressed air tank. In certain embodiments, an internal algorithm monitors the internal pressure of the inflation bladder and modifies the solenoid valve opening time to match the patient's range of motion with the degree of flexion stimulated by the system.

In certain embodiments, the presently disclosed subject matter provides systems for providing therapeutic stretch in an immobile person without inducing a calf muscle stretch reflex such as when the inflation occurs in a time interval of about 3 seconds to about 10 seconds. In certain embodiments, a stretch therapy protocol is initiated to provide therapeutic stretch. In certain embodiments, a stretch therapy protocol is initiated for preprogrammed frequencies throughout the day. In some embodiments, the stretch therapy protocol includes 15-30 dorsiflexion events per foot over a treatment period. In certain embodiments the treatment periods occur 3-12 times per day. In certain embodiments the treatment periods occur 3-12 times at set intervals over a 12 hour period to not disrupt sleep. In certain embodiments, the inflation during a stretch therapy protocol causes slow flexion which provides therapeutic stretch without inducing a calf muscle reflex. In certain embodiments, the inflation during a stretch therapy protocol occurs in a time interval of about 3 seconds to about 10 seconds. In certain embodiments, a stretch therapy protocol is used for treating a patient with limited ankle range of motion (ROM). In certain embodiments, the stretch therapy protocol determines the patient's ankle ROM by measuring the peak internal pressure during a calibration cycle. In certain embodiments, a stretch therapy protocol includes a calibration cycle comprising an inflation, hold, and deflation cycle; and wherein the processor arrangement monitors the peak internal pressure of the inflation bladder during the calibration cycle. In certain embodiments, the system stores, and monitors changes in the patient's ankle ROM over time.

The presently disclosed subject matter provides methods for providing therapeutic dorsiflexion to an immobile person. An example method includes placing the foot of an immobile person in a wearable boot comprising an inflation bladder disposed between the boot and the foot of the immobile person, where the inflation bladder is configured to flex the top of the foot about 15° to about 40° dorsally when the inflation bladder is inflated to a set pressure. Compressed air is provided to the inflation bladder, while the internal pressure of the inflation bladder is monitored to determine the ankle range of motion (ROM) of the immobile person. In certain embodiments, the inflation of the inflation bladder is adjusted to accommodate the patient's ankle range of motion (ROM) and the therapy occurs in predetermined intervals for set periods of time throughout the day to provide high-volume therapy without requiring clinician interference or disrupting patient sleep.

### BRIEF DESCRIPTION OF THE FIGURES

FIGS. 1A-C illustrate an exemplary wearable boot and head unit.

FIGS. 2A-2B illustrate an exemplary system for detecting internal pressure during bladder inflation (A) and monitoring a patient's ankle range of motion (ROM) by measuring the internal pressure (B).

FIG. 3 illustrates an exemplary operation mode for providing therapeutic stretch treatment by adjusting bladder inflation parameters to accommodate the patient's ankle range of motion (ROM).

FIG. 4A-4D illustrates an exemplary operation mode for stretching a calf muscle and inducing a calf muscle stretch reflex.

FIG. 5 illustrates an exemplary automated foot flexion device with a mechanical actuator.

FIGS. 6A-6C illustrate exemplary automated foot flexion devices with pneumatic, hydraulic or electric actuation.

FIG. 7A-7B illustrate an exemplary automated foot flexion boot with a rigid frame and inflatable bladder.

FIG. 8 illustrates exemplary head unit.

FIG. 9A-9B illustrate an exemplary foot flexion with uninflated bladder (A) and inflated bladder (B).

FIGS. 10A-10B illustrate hemodynamic conditions in the human leg veins in response to a pneumatic compression device and during automated foot flexion inducing muscle contraction.

FIG. 11A-11B illustrate an exemplary automated foot flexion device with a rigid frame and rounded inflation bladder.

### DETAILED DESCRIPTION

Patients with profound immobility, particularly during critical illness may experience complications in the foot/ankle axis resulting in reduced ankle range of motion, ankle contractures, foot drop, and a loss of the ability to stand or ambulate. These complications can significantly reduce the quality of life and health of survivors of critical illness. The onset of these complications results from local muscle atrophy, inflammation, and nerve degradation resulting from immobility. Physical therapy aims to prevent these complications through early mobilization and other strategies to stimulate and mimic natural activity. However, it is costly and impractical to have physical therapists and other clinicians provide therapy at a duration and frequency that recapitulates natural activity levels.

The present disclosure provides automated devices, methods, and systems for generating therapeutic muscle stretch and contraction. The present disclosure is based in part on the discovery that rapid ankle dorsiflexion elicits a muscle stretch reflex response in the muscles of the calf causing an active muscle contraction. This response recapitulates critical physiological responses in the body that mimic natural movement and ambulation. The induction of this response in high frequency in otherwise immobile patients can provide a therapy that offsets the physical decline and degradation of immobile patients.

The disclosed subject matter provides an automated system capable of delivering therapeutic dorsiflexion by automatically adapting the degree of foot dorsiflexion to accommodate the patient's ankle range of motion (ROM). Adapting the degree of dorsiflexion to the patients' range of motion ensures that consistent results are achieved (e.g., calf muscle reflex, therapeutic stretching) while not overextending the foot. In certain embodiments, the automated system can monitor the patient's ankle range of motion by sensing the peak internal pressure of the inflation bladder during an inflation cycle, and can adjust the applied forces (e.g., inflation pressure) such that the applied forces will be reduced to prevent injury in patients with low ankle ROM and the applied forces will be increased in patients with high ankle ROM. Adjusting the applied forces to the patient's ankle ROM ensures that sufficient stretch is achieved to provide therapeutic benefit without preventing injury. The disclosed subject matter provides benefits for patients with reduced ankle range of motion (ROM) by providing therapeutic stretch thereby restoring the patient's ankle ROM.

Devices and methods and systems for generating therapeutic muscle stretch and contraction are presented. In certain embodiments, an inflation bladder is disposed within a wearable boot. The inflation bladder inflates and deflates to dorsiflex the foot of person. Dorsiflexion drives calf muscle stretch causing an immobile tightening/lengthening to drive venous return of the blood volume within the calf. In certain embodiments, rapid flexion generates muscle contraction in the calf muscles to stimulate rapid venous flow, in veins throughout the leg up into the groin area, with hemodynamics comparable natural muscular activity and with greater velocity that using typical pneumatic compression calf devices that stimulate blood flow through compression of veins rather than through muscle contractions. The rapid pulse of venous flow and activated muscles improve perfusion of the limb, which is often decreased in immobile patients. The stimulation of muscle contraction may preserve natural muscle tone, improve perfusion, and stimulate nervous function in a patient who is highly immobile and provide therapeutic benefits. For example, consistent actuation throughout a period of immobility, at intervals of at least 500 flexions per leg per day, will provide biochemical and physical protection against muscle atrophy, tissue breakdown, and stimulate nervous connections.

The calf muscle stretching/lengthening induced by the device also provides therapeutic effects to the calf muscle, ankle, and foot. Immobile patients often develop reduced range of motion in their ankles due to calf muscle atrophy and shortening and general stiffening and swelling of the ankle joint due to immobility. Passive stretching is an optimal treatment for these patients to preserve and improve ankle range of motion. However, there is a dose-dependent response to the stretching therapy and it is often challenging in clinical environments to have clinicians carry out sufficient volume of ankle stretching for optimal outcomes. Patients who have limited ankle range of motion may have trouble with standing and ambulating, be at a higher risk of falls, and could develop long term complications of ankle contracture or foot drop. The devices, methods, and systems disclosed herein, provide automated therapeutic foot dorsiflexion that is adapted to the patient's ankle range of motion (ROM), thereby providing therapeutic stretch without overextension and provide the therapy in high volumes at set intervals without disrupting clinical care.

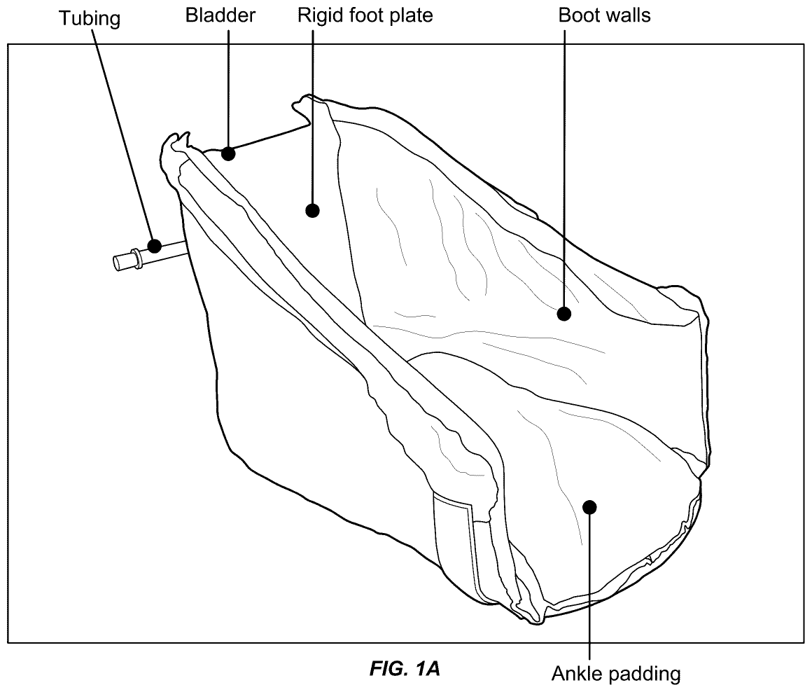

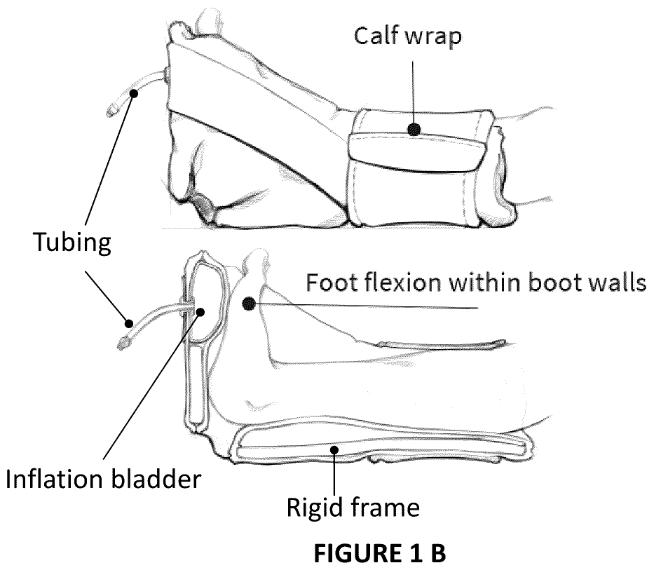

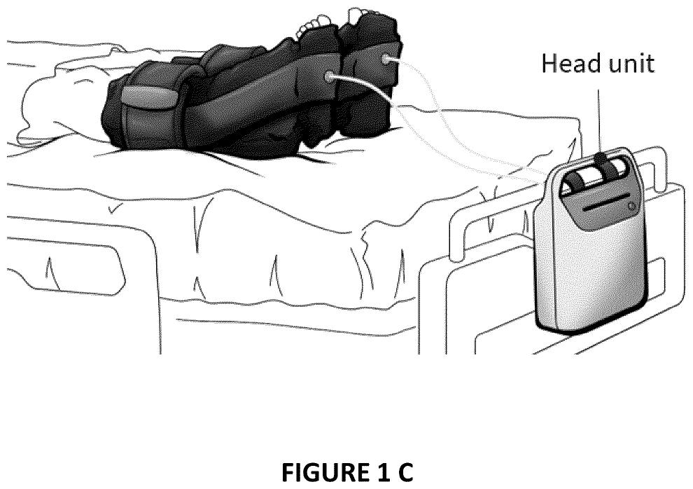

With reference to FIG. 1A for the purpose of illustration and not limitation, there is provided a schematic illustrating an exemplary wearable boot. The wearable boot can include a rigid frame, that resists deformation during bladder inflation, an inflation bladder, and a rigid foot plate. In some embodiments, the bladder is disposed between the rigid frame and the rigid foot plate. Tubing can pneumatically couple the inflation bladder to a head unit. The rigid frame can attach to a foot of the immobile person and extend to the ankle of the immobile person. In some embodiments, the rigid frame can be covered in fabric, foam padding, gel padding, air-filled padding and the like to maximize user comfort. In some embodiments, the wearable boot comprises boot walls that extend from the ankle to the calf of the immobile person. In some embodiments the wearable boot comprises ankle padding.

With reference to FIG. 1B for the purpose of illustration and not limitation, there is provided a schematic illustrating an exemplary system for generating therapeutic foot dorsiflexion. A wearable boot can be attached to the foot of the immobile person and extend to (or slightly above) the ankle of the immobile person. A calf wrap can secure the rigid frame to the leg of the immobile person. The rigid frame can include an inflation bladder disposed between the rigid frame and the foot. Tubing can pneumatically couple the inflation bladder to a head unit. The tubing connection can be located on the bottom or the side of the bladder thereby preventing disruption of the bladder during inflation and deflation.

In certain embodiments, the inflation bladder can inflate, hold, and deflate such that the rapid flexion (e.g., when inflation occurs in time intervals of about 0.25 seconds to about 0.5 seconds) induced by the inflation bladder stretches the calf muscle and induces a muscle reflex associated with muscular activity. In certain embodiments, the inflation bladder can inflate, hold, and deflate such that the slow flexion (e.g., when inflation occurs in time intervals of about 3 seconds to about 10 seconds) induced by the inflation bladder stretches the calf muscle without inducing a muscle reflex thereby providing therapeutic stretch that elongates and lengthens the muscles, tendons, and other soft tissue of the area to improve range of motion. In some embodiments, the inflation bladder can be wedge-shaped. In some embodiments, the inflation bladder is adapted to be deflated to about 10 mmHg such that the inflation bladder can be re-inflated more rapidly and with less noise generation but does not create any measurable foot flexion. The inflation bladder can be smoothly re-inflated to ensure uniform inflation.

In some embodiments, the inflation bladder is filled to a predetermined pressure. In certain embodiments, the bladder is inflated to a set pressure of about 3 psi (150 mmHg) to about 15 psi (750 mmHg) during an inflation cycle. In some embodiments, inflation bladder pressure controls the angle of dorsiflexion. In some embodiments, the inflation bladder is filled to cause about 15° to about 40° degrees of dorsiflexion. In some embodiments, the predetermined pressure is calibrated based on the ankle range of motion (ROM) of the immobile person. In some embodiments, the inflation bladder is filled to a predetermined pressure with variable inflation time.

With reference to FIG. 1C for the purpose of illustration and not limitation, there is provided a schematic illustrating an exemplary system comprising two wearable boots coupled to an exemplary head unit. The head unit is pneumatically coupled to the inflation bladder in the wearable boot via a tube that allows sufficient air volume flow to the bladder to support the designated inflation parameters. In certain embodiments, the head unit is pneumatically coupled to a left and right wearable boot.

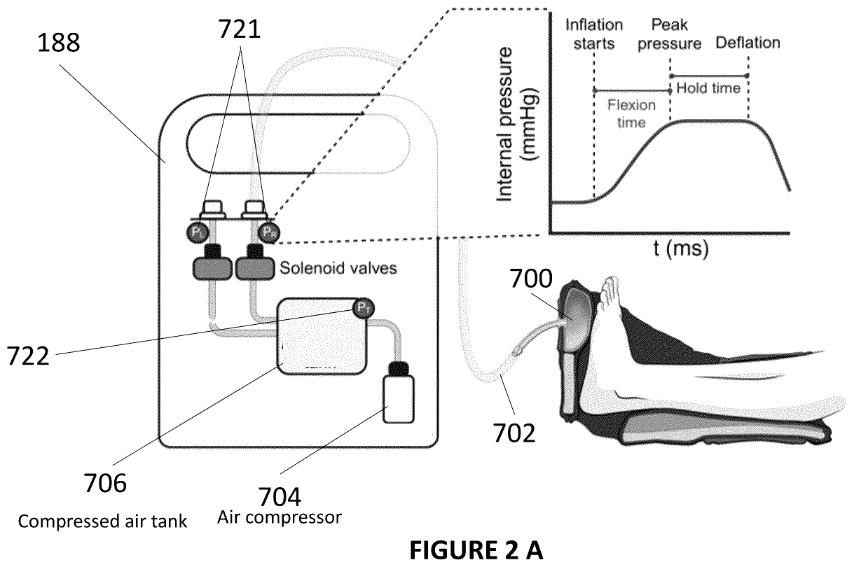

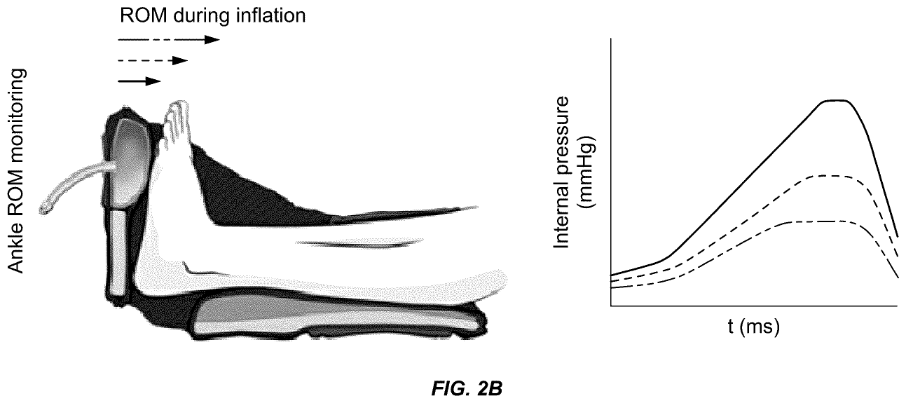

With reference to FIG. 2A for the purpose of illustration and not limitation, there is provided a schematic illustrating an exemplary system for generating therapeutic foot dorsiflexion. The head unit 188 is pneumatically coupled to the inflation bladder 700 via a tube 702 that allows sufficient air volume flow to the bladder 700 to support the designated inflation parameters. The head unit 188 can have an air compressor 704 and a compressed air tank 706. In some embodiments, the head unit 188 can include a solenoid valve. The solenoid valve can regulate the release of the compressed air from the compressed air tank 706 to the inflation bladder 700 by opening and closing. In some embodiments, the head unit 188 can include one or more pressure sensors (e.g., 721, 722). In some embodiments, at least one pressure sensor 721 is configured to monitor the internal pressure of the inflation bladder 700. In some embodiments, at least one pressure sensor 721 is configured to monitor air pressure within the air tubing connecting the solenoid valve to the bladder within the boot. In some embodiments, one pressure sensor is configured to monitor air pressure within the air tubing connecting the solenoid valve to the bladder within a right boot (P_{R}) and one pressure sensor is configured to monitor air pressure within the air tubing connecting the solenoid valve to the bladder within a left boot (P_{L}). In certain embodiments, at least one pressure sensor 722 (P_{T}) can monitor air pressure of the compressed air tank 706 and direct the air compressor 704 to restore the air pressure to a pre-determined level.

In some embodiments, the head unit 188 comprises a processor arrangement that can cause the head unit to provide compressed air to the inflation bladder and monitor the internal pressure of the inflation bladder during inflation. In certain embodiments, the processor arrangement comprises an electronic controller comprising a printed circuit board (PCB) with non-transitory memory and a processor communicatively coupled to the non-transitory memory. In some embodiments, the processor arrangement is communicatively coupled to the at least one pressure sensor within the head unit and can monitor the air pressure of the compressed air tank. In some embodiments, the processor arrangement is communicatively coupled to the air compressor within the head unit and can regulate the duration of the air compressor activity. In some embodiments, the processor arrangement is communicatively coupled to a solenoid valve within the head unit and can control the opening and closing of the solenoid valve.

In some embodiments, the air compressor 704 is pneumatically coupled to the compressed air tank 706 and can fill the compressed air tank 706 with compressed air to a pre-determined tank pressure. In some embodiments, the processor arrangement monitors the air pressure of the compressed air tank while the air compressor is filling the compressed air tank. In some embodiments, the processor arrangement ensures that the tank is filled to the pre-determined tank pressure by regulating the duration of air compressor activity.

In certain embodiments, the air tank is filled to a pre-determined tank pressure which is monitored by the processor arrangement within the head unit. In certain embodiments, the tank is filled to a pressure of about 5 psi to about 25 psi. The processor arrangement can then inflate the inflation bladder by opening the solenoid valves, thereby releasing the compressed air from the compressed air tank 706 to the inflation bladder 700 via the tube 702. In certain embodiments, the release of air can be regulated by the opening and closing of the solenoid valves. In some embodiments, the frequency and duration of the opening of the valve can be programmed into a printed circuit board (PCB) controller within the head unit 188 and set using user interface controls. In some embodiments, the frequency and duration of the opening of the valve can be automatically adjusted by an internal algorithm within the processor arrangement.

In certain embodiments, the head unit 188 includes an LED screen user interface. The controller can control the head unit 188 to trigger inflation and foot actuation with bursts of air that preferably inflate the inflation bladder 700. In certain embodiments, the bursts of air are preferably from about 200 milliseconds to about 300 milliseconds long (e.g., for generating calf muscle reflex). In certain embodiments, the burst of air are preferably from about 1 second to about 10 seconds in length (e.g., for generating therapeutic stretch). As the compressed air tank 706 releases compressed air, the inflation bladder 700 can inflate. When the compressed air tank 706 stops releasing compressed air, the inflation bladder 700 can deflate through a pressure release valve, preferably disposed within the head unit 188.

With reference to FIG. 2B for the purpose of illustration and not limitation, there is provided a schematic illustrating an exemplary system for monitoring a patient's ankle range of motion (ROM) by detecting the peak internal pressure of the inflation bladder during an inflation cycle. In some embodiments, the head unit 188 can include a processor arrangement comprising non-transitory memory and a processor communicatively coupled to the non-transitory memory. In some embodiments, the processor arrangement is configured to automatically measure the internal pressure of the inflation bladder. In some embodiments, the patient's ankle range of motion (ROM) is determined through a calibration cycle. In certain embodiments, the calibration cycle comprises an inflation, hold, and deflation cycle. In certain embodiments, the processor arrangement monitors the peak pressure of the inflation bladder during the calibration cycle. In certain embodiments, the processor arrangement monitors the time to peak pressure during the calibration cycle. In some embodiments, the peak pressure and time to peak pressure are measured during a calibration cycle and correlate to the patient's ankle range of motion (ROM). In some embodiments, the processor arrangement monitors the ankle range of motion (ROM) of the immobile patient by measuring the internal pressure of the inflation bladder.

In certain embodiments, a stretch therapy protocol (e.g., operation mode for stretching muscle without inducing a reflex) is initiated for preprogrammed frequencies throughout the day. In some embodiments, the stretch therapy protocol includes 15-30 dorsiflexion events per foot over a treatment period. In certain embodiments, a calibration cycle is initiated before a therapeutic stretch therapy protocol. In certain embodiments, the system comprise a processor arrangement is communicatively coupled to a non-transitory memory and the non-transitory memory stores instructions to initiate about 5 to about 10 therapeutic stretch therapy protocols per day or about 5 to about 10 therapeutic stretch therapy protocols within a 12 hour window. In certain embodiments, the non-transitory memory stores instructions to initiate a calibration cycle before each stretch therapy protocol. In certain, embodiments the processor arrangement measures, calculates, and stores the patient's ankle ROM based on the peak internal bladder pressure detected during each calibration cycle. In some embodiments, individual patient's ankle ROM is calculated on a set schedule (e.g., inflation, hold, and deflation) to monitor contracture onset. In certain embodiments, the patient's calculated ROM is used to tailor a treatment therapy. In certain embodiments, the air flow volume is adjusted to alter the duration of the “hold” period. In certain embodiments, the air flow volume is adjusted to prevent over-flexion or insufficient flexion.

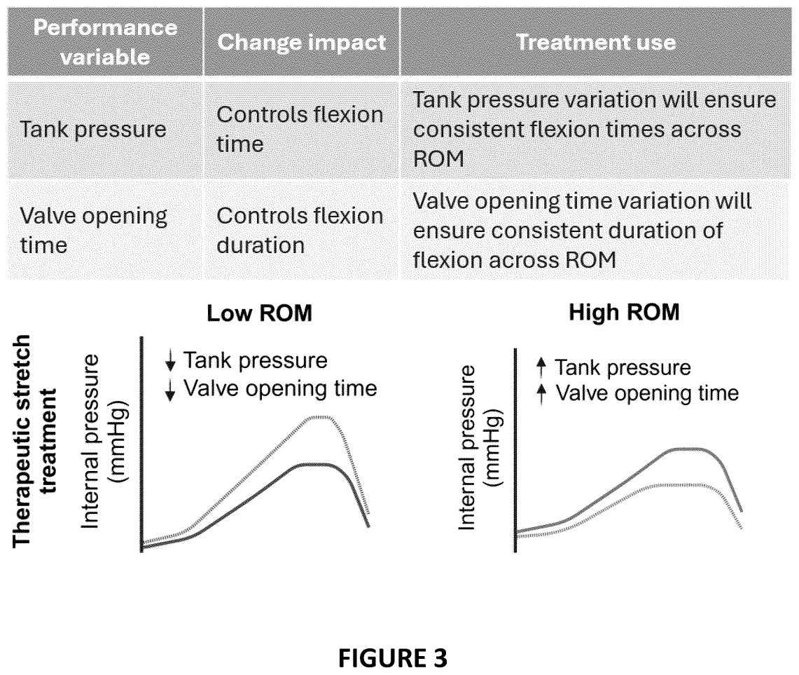

With reference to FIG. 3 for the purpose of illustration and not limitation, there is provided a schematic illustrating exemplary inflation parameters for generating therapeutic dorsiflexion using the presently disclosed system. In certain embodiments, the inflation parameters can be programmed into a printed circuit board (PCB) controller within the head unit and set using user interface controls. In certain embodiments, an internal algorithm within the processor arrangement of the head unit controls the inflation parameters. In certain embodiments, the inflation parameters comprise tank pressure. In certain embodiments, the inflation parameters comprise valve (e.g., solenoid valve) opening time. In certain embodiments, the inflation parameters comprise tank pressure and valve opening time. In certain embodiments, the tank pressure is adjusted to ensure consistent flexion times across the patient's ankle range of motion (ROM). In certain embodiments, the tank pressure is adjusted by an internal algorithm within the processor arrangement of the head unit. In certain embodiments, the valve opening time is adjusted to ensure consistent flexion duration across the patient's ankle range of motion (ROM). In certain embodiments, the valve opening time is adjusted by an internal algorithm within the processor arrangement of the head unit. In certain embodiments, the tank pressure and valve opening time are adjusted to ensure consistent flexion times and consistent flexion duration across the patient's ankle (ROM). In certain embodiments, the tank pressure and valve opening time are adjusted by an internal algorithm within the processor arrangement of the head unit. In certain embodiments, the tank pressure is decreased to accommodate a patient with low ankle ROM. In certain embodiments, the tank pressure is increased to accommodate a patient with high ankle ROM. In certain embodiments, the valve opening time is decreased to accommodate a patient with low ankle ROM. In certain embodiments, the valve opening time is increased to accommodate a patient with high ankle ROM.

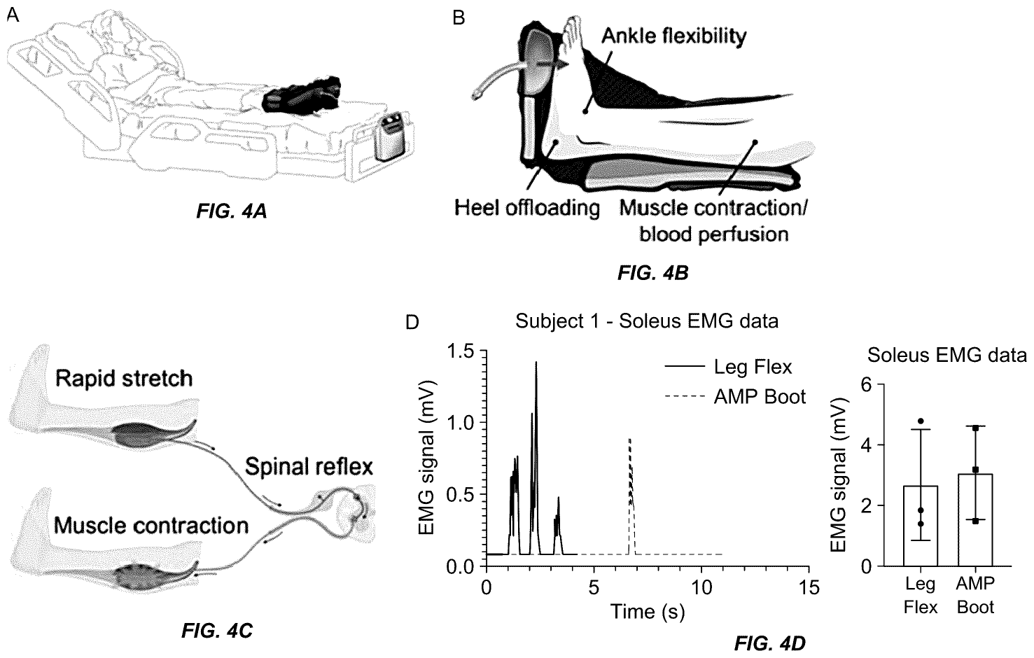

With reference to FIG. 4A for the purpose of illustration and not limitation, there is provided a schematic illustrating an exemplary system disclosed herein comprising two wearable boots coupled to an exemplary head unit.

With reference to FIG. 4B for the purpose of illustration and not limitation, there is provided a schematic illustrating an exemplary actuation (e.g., dorsiflexion) induced by an exemplary wearable boot on the subject.

With reference to FIG. 4C for the purpose of illustration and not limitation, there is provided a schematic illustrating an exemplary mechanism of action for inducing muscle contraction through rapid foot dorsiflexion.

With reference to FIG. 4D for the purpose of illustration and not limitation, there is provided a graph illustrating experimental data showing electromyography (EMG) readings of muscle contraction reported in units of voltage recorded from the soleus muscle of healthy subjects. (D, left) Graph showing the EMG data from a single subject. The subject actively flexed their leg to induce baseline EMG measurement (Leg Flex). The exemplary system being used on the leg during immobility (AMP Boot). (D, right) Graph of the average EMG signal during an active leg flex or exemplary system function from healthy volunteers (n=3).

In certain embodiments, the system disclosed herein generates a calf muscle contraction that produces an electromyograph reading (EMG) of at least about 0.1 mV, at least about 0.2 mV, at least about 0.3 mV, at least about 0.4 mV, at least about 0.5 mV, at least about 1.0 mV, at least about 1.5 mv, at least about 2 mV, or at least about 2.5 mV.

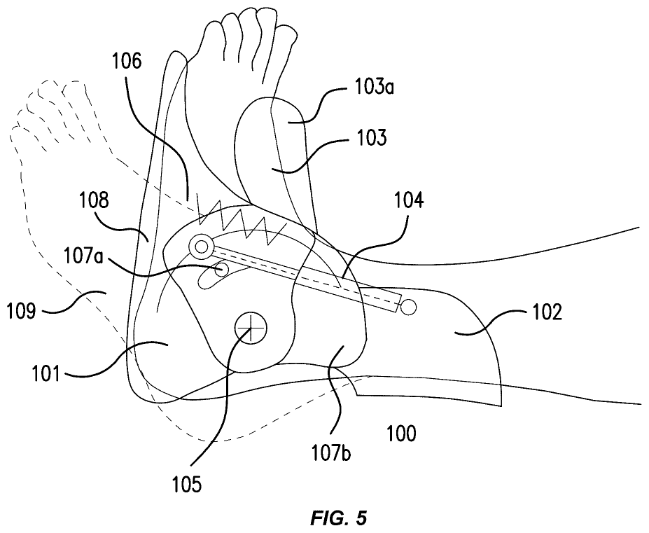

With reference to FIG. 5 for the purpose of illustration and not limitation, there is provided a schematic illustrating an exemplary device 100. The device 100 includes a foot holster 101, ankle brace 102, and compression holder 103. The foot flexion is driven by the mechanical action of the actuator 104. This drives foot flexion towards the patient's head while in a prone position, activating calf tightening, and pushing the foot into the compression holder 103 to drive blood out of the foot 109. The compression holder can include any type of padding or compressible material such as foams, gel padding, air-filled padding and the like. FIG. 5 also includes a frame pivot 105, compression spring 106, limit screws 107a and 107b and a flexion pad or foot plate 108. The compression spring 106 preferably provides a preset amount of compressive force that can be modified by changing the spring properties and achieving a minimum compressive force of 100 mmHg. The extent of compression can also be controlled by any material that provides a progressive degree of resistance including springs, elastic bands and the like, that connects the top plate (or top part) 103a and the compression holder 103 to the foot holster 101.

FIG. 5 also illustrates foot position 109 represented by dotted lines, showing the foot in the un-flexed position of the device. The parts can be connected by nuts and bolts. The foot holster 101 is preferably configured to rotate in response to actuator 104. The top part (or top plate) 103a of the compression holder 103 also rotates when the foot is pressed into it to allow for foot flexion to be achieved, and simultaneous compressive forces are applied by tension in the compression spring 106.

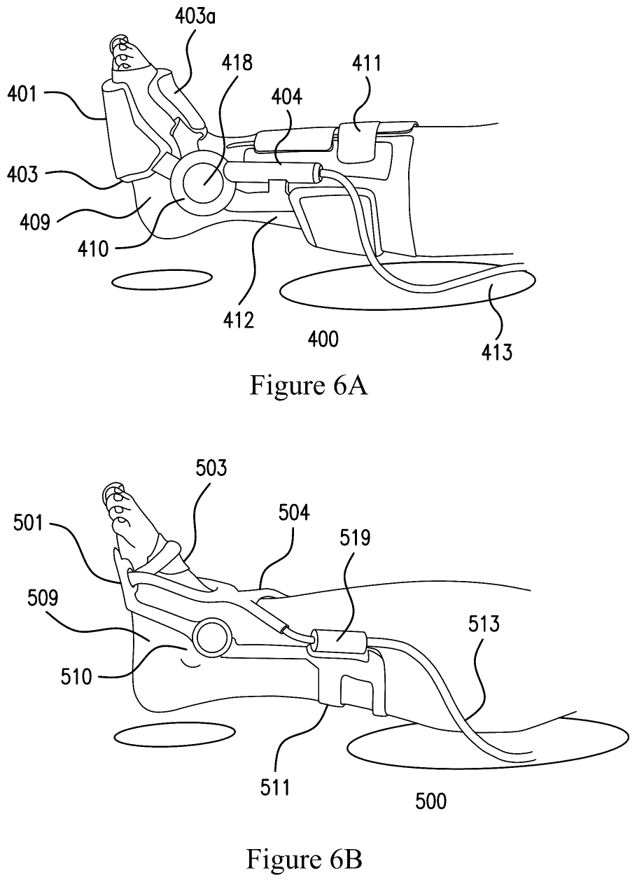

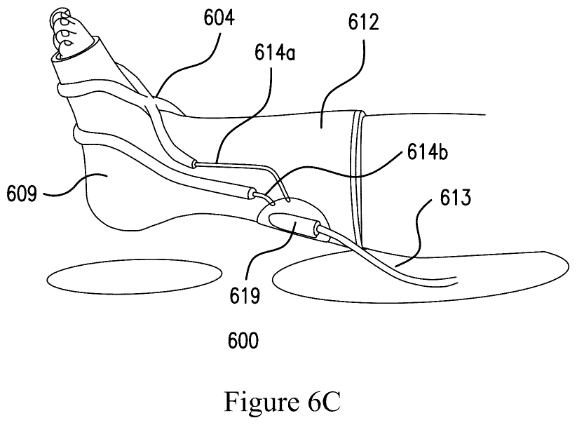

With reference to FIGS. 6A-C for the purpose of illustration and not limitation, there is provided a schematic illustrating exemplary devices with pneumatic actuation, electric, or hydraulic actuation.

With reference to FIG. 6A for the purpose of illustration and not limitation, there is provided a schematic illustrating an exemplary device 400. The device 400 includes a foot holster 401 that can be made of a semi-rigid plastic cover or other materials and containing compressible padding 403. The foot flexion is driven by the hydraulic, pneumatic or electric drive piston 404. This drives foot flexion towards the patient's head while in a prone position, activating calf tightening, and pushing the foot into the cushioning 403 to drive blood out of the foot 409. FIG. 6A also includes a disc cover 410, clastic sock 412, Velcro fastening straps 411 for securing the elastic sock and a fluid/air or power line 413. This device 400 will function by pneumatic/hydraulic pressure being applied through fluid/air power line 413 driving piston action in drive piston 404, and rotating foot holster 401, containing padding 403, at the pivot point 418. The top plate 403a that contains compressible padding 403 is not actuated, and flexes as the foot 409 is pressed into it but has a tension that resists flexion providing compression. The elastic sock 412 is secured with Velcro, the frame is attached to the sock with stitching. Cushioning 403 is adhered to foot holster 401. Foot holster 401 is welded/screwed to pivot point 418 in 410 housing. Top plate 403a is attached to rotating foot holster 401 with springs or other tension-creating material within disc cover 410's housing.

With reference to FIG. 6B for the purpose of illustration and not limitation, there is provided a schematic illustrating an exemplary device 500. The device includes an air muscle 519 connected to air line 513. FIG. 6B also includes a foot holster 501 that can be made of a semi-rigid plastic cover or other materials and a top plate 503 that can secure the foot to the foot holster 501. This device 500 will function by function by pneumatic/hydraulic pressure being applied through the air line 513 to inflate the air muscle 519. Inflation of the air muscle 519 inflates and shortens the length of the tubing 604, thereby pulling the foot toward the head at the pivot point 510, and inflates the tubing 504 that presses on the foot 509.

With reference to FIG. 6C for the purpose of illustration and not limitation, there is provided a schematic illustrating an exemplary device 600. The device 600 includes an air muscle 619 connected to air line 613 by connectors 614a and 614b. FIG. 6C also includes a soft elastic sock 612, which provides a connection point for the tubing to be stabilized in space during patient use and helps disperse the compressive force. This device 600 functions similarly to FIG. 6B where inflation of the air muscle 619 shortens the length of the tubing (air muscle) pulling the foot towards the head and inflates the tubing 604 that presses on the foot 609. The air muscle 619 attached to clastic sock 612 in FIG. 6C can be attached with stitching and adhesives.

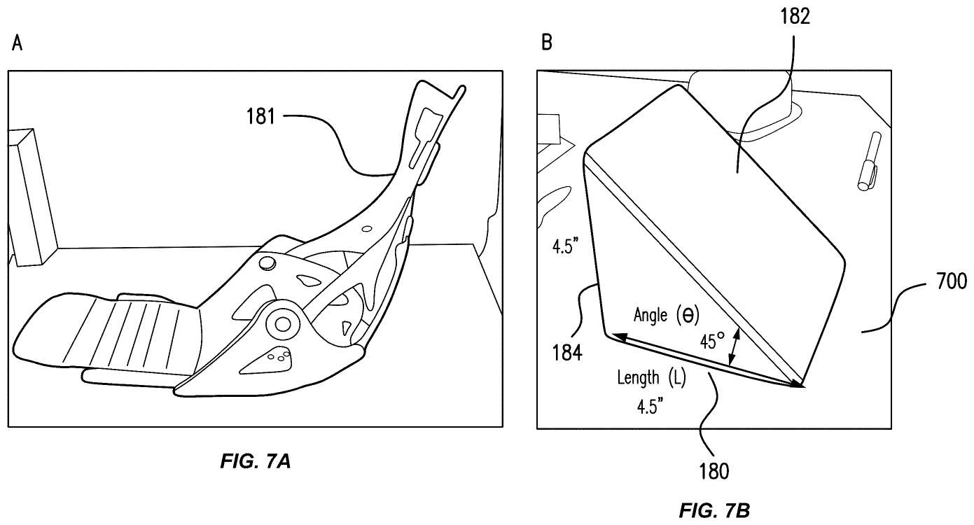

With reference to FIGS. 7A-7B for the purpose of illustration and not limitation, there is provided a schematic illustrating an exemplary device.

With reference to FIG. 7A for the purpose of illustration and not limitation, there is provided a schematic illustrating an exemplary wearable boot. The wearable boot can include a rigid frame 181. The rigid frame 181 can attach to a foot of the immobile person and extend to the ankle of the immobile person. In some embodiments, the rigid frame 181 can be covered in fabric, foam and padding to maximize user comfort.

With reference to FIG. 7B for the purpose of illustration and not limitation, there is provided a schematic illustrating an exemplary inflation bladder 700. The inflation bladder 700 can inflate and deflate such that simultaneous rapid flexion and compression induced by the inflation bladder 700 induces the venous valve oscillatory flow to preserve the natural mechanism of DVT prevention associated with muscular activity. In some embodiments, the inflation bladder 700 can be wedge-shaped. In some embodiments, the inflation bladder is adapted to be deflated to about 10 mmHg such that the inflation bladder can be re-inflated more rapidly and with less noise generation but does not create any measurable foot flexion. The inflation bladder can be smoothly re-inflated to ensure uniform inflation. In some embodiments, the inflation bladder has a base face 180 with length of approximately 4.5 inches and a forward face 184 having a length of approximately 4.5 inches. Preferably, when fully inflated a top face 182 of the inflation bladder forms an angle of approximately 45 degrees with the base face 180.

With reference to FIG. 7C for the purpose of illustration and not limitation, there is provided a schematic illustrating an exemplary head unit 188. The head unit 188 is pneumatically coupled to the inflation bladder 700 via a ⅜ inch inner diameter tube 702 that allows sufficient air volume flow to the bladder 700 to support the designated inflation times. The head unit 188 can have an air compressor 704 and a compressed air tank 706. The air compressor 704 can be pneumatically coupled to the compressed air tank 706 and fill the compressed air tank 706 with compressed air to a pre-determined pressure set and monitored by the electronic controller. The compressed air tank 706 can then release the compressed air, by opening solenoid valves built into the head unit 188 and controlled by the electronic controllers within the head unit 188, to the inflation bladder 700 to drive inflation thereof via the tube 702. The release of air can be regulated by the opening and closing of the solenoid valves. The frequency and duration of the opening of the valve can be programmed into a printed circuit board (PCB) controller within the head unit 188 and set using user interface controls. In some aspects, the head unit 188 includes an LED screen user interface. The controller can control the head unit 188 to trigger inflation and foot actuation with bursts of air that preferably inflate the inflation bladder 700. The bursts of air are preferably from about 200 milliseconds to about 300 milliseconds long. As the compressed air tank 706 releases compressed air, the inflation bladder 700 can inflate. When the compressed air tank 706 stops releasing compressed air, the inflation bladder 700 can deflate through a pressure release valve, preferably disposed within the head unit 188. The compressed air tank 706 can repeatedly inflate and deflate the inflation bladder 700 such that motion of the inflation bladder 700 causes foot movement to induce the venous valve oscillatory flow in the leg veins of the immobile person to preserve the natural mechanism of DVT prevention associated with muscular activity. In certain embodiments, the rapid inflation of the inflation bladder stretches a calf muscle of the immobile person and induces a calf muscle reflex (e.g., when inflation occurs in a timer interval of about 0.25 seconds to about 0.5 seconds). In certain embodiments, the slow inflation of the inflation bladder stretches a calf muscle of the immobile person without inducing a calf muscle reflex (e.g., when inflation occurs in a time interval of about 1 second to about 10 seconds). The actuation bursts preferably have a minimum intervening dwell time configured to restore venous pressures to pre-actuation levels. Preferably, the intervening dwell time is about 10 seconds. In some embodiments, the intervening dwell time is greater than 10 seconds. In some embodiments, the intervening dwell time is greater than 5 seconds. In some embodiments, the intervening dwell time is about 1 minute. The intervening dwell time can allow the physical actuation to drive the same amount of venous return in response to actuation. When venous pressure is depleted further actuations result in decreasing flow and limited reversing flow in the valve sinus rendering the device less effective. The head unit can be coupled to a wearable boot and can be configured to induce the periodic dorsiflexion and increased compression in a predetermined time cycle. The predetermined time cycle can include a plurality of dorsiflexion time periods, wherein each dorsiflexion time period is followed by a intervening dwell time. In an embodiment, the dorsiflexion time period is between 0.1 seconds and 0.5 seconds and the intervening dwell time is at least 10 seconds. In aspects of the invention the dorsiflexion time period is less than 0.5 seconds, less than 0.4 seconds, less than 0.3 seconds or less than 0.2 seconds.

In some embodiments, the head unit 188 can include a solenoid valve 718. The solenoid valve 718 can be placed along the tube 702 connecting compressed air tank 706 and the inflation bladder 700 and can regulate the release of the compressed air from the compressed air tank 706 to the inflation bladder 700 by opening and closing. In some embodiments, the head unit 188 can include at least one pressure sensor 189. The at least one pressure sensor 189 can monitor air pressure of the compressed air tank 706 and direct the air compressor 704 to restore the air pressure to the pre-determined level. In some embodiments, the head unit 188 can include at least one pressure relief valve 708. The pressure relief valve 708 can monitor air pressure of the inflation bladder 700 and relieve air pressure to prevent over-inflation thereof. In some embodiments, the head unit 188 can include a control board 710. The control board 710 can be electrically coupled to the air compressor 704 such that the control board 710 initiates inflation of the inflation bladder and to control parameters of inflation. The head unit 188 can include a power board 187.

The power board 187 can be configured to provide power to compressor 704, control board 710, and pressure sensor 189. In an embodiment, power board 187 receives power from an external source. In another embodiment, power board 187 receives power from an internal source, such as a battery contained within head unit 188. The head unit 188 can include an external casing 189 that can be designed to limit creases and ridges to allow for efficient sterilization.

With reference to FIG. 7D for the purpose of illustration and not limitation, there is provided a schematic illustrating an exemplary device 600. A rigid frame 181 can be attached to the foot of the immobile person and extend to (or slightly above) the ankle of the immobile person. An ankle wrap 186 can secure the rigid frame 181 to the leg of the immobile person. In certain embodiments, a compression band 185 can secure the rigid frame to the foot of the immobile person. In certain embodiments, the device does not comprise a compression band. The rigid frame 181 can include an inflation bladder 700 disposed between the rigid frame 181 and the foot. Tubing 702 can pneumatically couple the inflation bladder 700 to a head unit 188. The tubing connection can be located on the bottom or the side of the bladder thereby preventing disruption of the bladder during inflation and deflation. The inflation bladder 700 can inflate and deflate such that simultaneous rapid flexion and compression induced by the inflation bladder 700 induces the venous valve oscillatory flow to preserve the natural mechanism of DVT prevention associated with muscular activity. For example, the inflation bladder is configured to cause 25° to 50° of dorsiflexion, beyond a neutral 90° position, at maximum inflation. In some embodiments, the inflation bladder is configured to cause approximately 45° of dorsiflexion, beyond a neutral 90° position. In some embodiments the inflation bladder is configured to cause 25° to 45° of dorsiflexion, beyond a neutral 90° position, 30° to 40° of dorsiflexion, beyond a neutral 90° position, or about 30° of dorsiflexion, beyond a neutral 90° position.

FIG. 7D further illustrates an exemplary device during the dwell period. The dwell period can be characterized by the inflation bladder being uninflated or inflated to a low threshold inflation (e.g., about 10 mmHg). During the dwell period illustrated in FIG. 7D, the compression band 185 can have no tension during the dwell period. In some embodiment, during the dwell period, compression band 185 have a low level of tension that, in some instances, permits the compression band to be retained in a selected position relative to the patient's foot.

FIG. 7E illustrates an exemplary device 600 during a dorsiflexion period. In the illustrated embodiment, inflation bladder 180 has been inflated to a maximum inflation level which has induced a dorsiflextion of a selected value from 25° to 45°. The compression band 185 in FIG. 7E is under tension. The tension of the compression band 185 during the dorsiflexion period is configured to induce blood flow from the patient's foot. Preferably, the compression band 185 is configured to apply at least 100 mmHg of pressure to the patient's foot during dorsiflexion. In one embodiment, as inflation bladder inflates, the tension in the compression band 185 increases. In some aspects the increase in tension is a linear increase in tension through the dorsiflexion period. FIG. 7 E further illustrates the position of inflation bladder 130 to substantially act on the ball of patient's foot. Preferably, inflation bladder 130 extends proximally to the patient's heel pad but does not extend under the heel. Inflation bladder 130 preferably extends distally to the patient's phalanges.

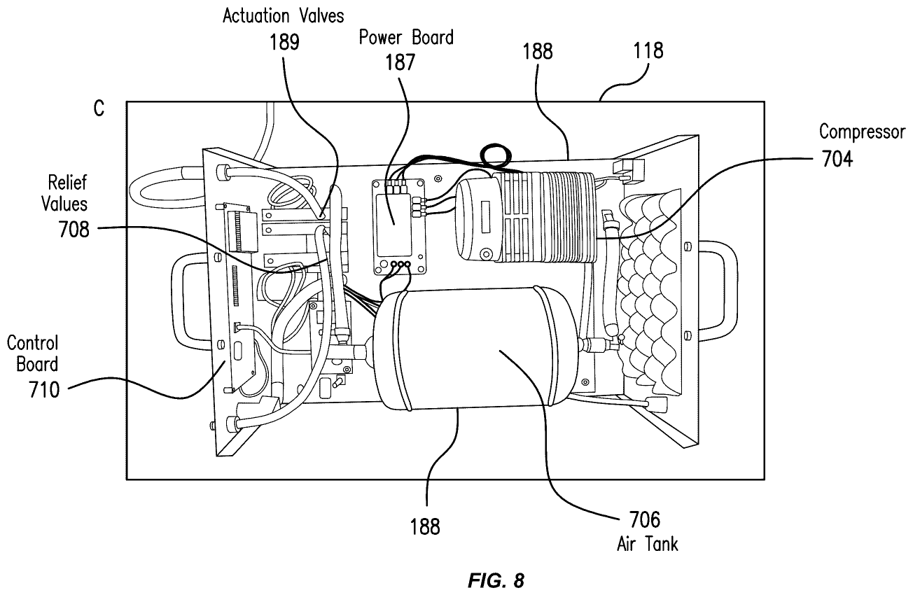

With reference to FIGS. 8A and 8B for the purpose of illustration and not limitation, there are provided graphs illustrating representative data from a single human subject quantifying the flow at a venous valve sinus (VVS) in a proximal vein measured by 2D Color Doppler. Venous return to the heart and reversing flow are shown. The timing of initiation of inflation of either the ICD or an exemplary device are shown with a dashed black line. The exemplary device corresponding to the depicted flow graphs was inflated for 300 ms and the tank pressure was at 25 psi. The Flow Velocity Index of forward and reversing flow within the valve sinus was measured by quantifying the intensity of the blue (forward) and red (reversing) pixels within the valve sinus region from the 2D color Doppler recording. The intensity of the pixels is displayed in arbitrary units from 0-100 by the Doppler imaging and is correlated to the flow. The average velocity in both directions is then calculated and reported as the Flow Index for each time interval during the recording period. The data in FIG. 8B was generated using device 600 shown in FIGS. 7A-7E.

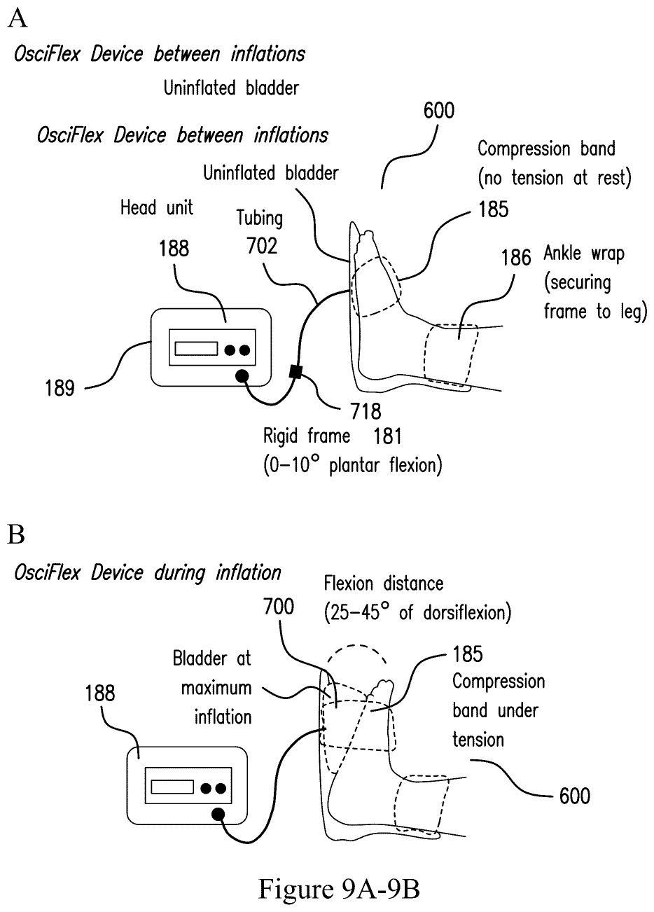

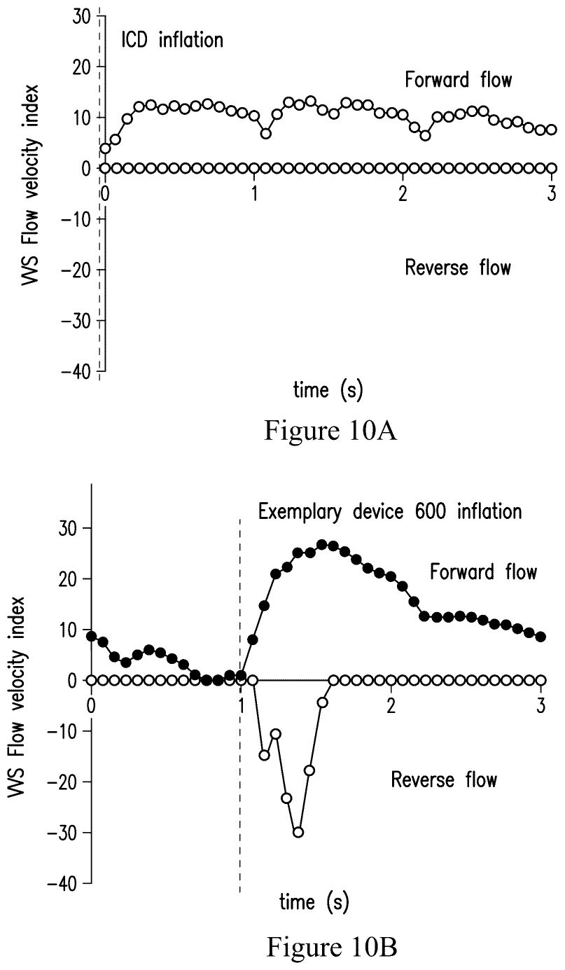

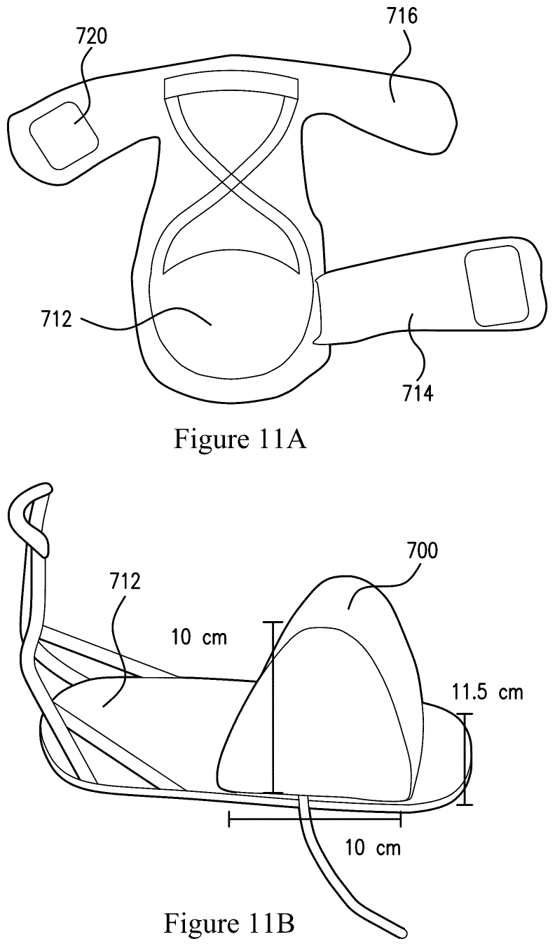

With reference to FIG. 9A for the purpose of illustration and not limitation, there is provided a schematic illustrating an exemplary device. The inflation bladder 700 can be disposed within a wearable boot 712. In some embodiments, the inflation bladder 700 can be a horizontal semi-cylinder such that a flat side of the inflation bladder 700 is adapted to lie on a foot plate of the wearable boot 712 or a full cylinder such that the inflation bladder 700 lays horizontally across a foot plate of the wearable boot 712. The inflation bladder 700 is adapted to drive foot flexion to 20-45 degrees of dorsiflexion beyond a neutral 90 degree foot position when supine.

With reference to FIG. 9B for the purpose of illustration and not limitation, there is provided a schematic illustrating an exemplary wearable boot. The wearable boot can include a rigid plastic frame 712 and a compression band 714. The compression band 714 is sized and fit so as to cover the metatarsal region of the foot but not to extend substantially beyond the metatarsal in the proximal direction. This focuses the compression on the plantar region of the foot where the venous plexus is located to create the compression force that drives the increased venous return. Further, the compression band position is away from the ankle and will not provide discomfort during ankle rotation during flexion. The rigid plastic frame 712 can attach to a foot of the immobile person and extend to the ankle of the immobile person. The compression band can secure the foot of the immobile person to the rigid plastic frame 712. In some embodiments, the rigid plastic frame 712 can be covered in fabric and padding 718 to maximize user comfort. In some embodiments, the compression band 714 can use a loop and hook material 718, where two sides are pressed together so hooks can engage loops, to secure the foot of the immobile person to the rigid plastic frame 712.

In certain embodiments, the system disclosed herein stretches a calf muscle without triggering a spinal reflex. In certain embodiments, the stretching the calf muscle produces an electromyograph reading (EMG) of less than about 0.005 mV, less than about 0.01 mV, less than about 0.02 mV, less than about 0.03 mV, less than about 0.04 mV, less than about 0.05 mV, less than about 0.1 mV, less than about 0.2 mV, less than about 0.3 mV, less than about 0.4 mV, or less than about 0.5 mV. Non-limiting example of embodiments of the present invention include the following:
(1) A device for stimulating ankle dorsiflexion in a patient, the device comprising a foot support assembly including a dorsiflexion inducing member configured to periodically urge a foot of the patient into dorsiflexion and a compression member configured to increase compression on a portion of the foot during the periodic dorsiflexion.
(2) The device of (1) wherein the periodic dorsiflexion and compression is configured to induce venous blood flow in a leg of the patient.
(3) The device of (1) wherein the periodic dorsiflexion is configured to induce calf muscle contraction of the patient.
(4) The device of (1) further comprising a controller coupled to the foot support assembly, configured to induce the periodic dorsiflexion in a predetermined time cycle, wherein the predetermined time cycle includes a plurality of dorsiflexion time periods, wherein each dorsiflexion time period is followed by a rest time.
(6) The device of (3), wherein the dorsiflexion time period is between 0.1 seconds and 0.5 seconds and the rest time period is at least 10 seconds.
(7) The device of (1)-(6) wherein the foot support assembly comprises a frame, wherein the dorsiflexion inducing member comprises an inflatable bladder configured and dimensioned to move the foot away from the frame when the foot support assembly is worn by the patient and the bladder is inflated.
(8) The device of (7) wherein the inflatable bladder is disposed between the frame and the foot.
(9) The device of (7)-(8) wherein the inflatable bladder is inflatable to a wedge-shaped configuration.
(10) The device of (7)-(9) wherein the inflatable bladder comprises a foot engaging surface that is configured and dimensioned to engage a ball of the patient's foot when the foot support assembly is worn by the patient, wherein at a peak inflation point the bladder terminates at a position that is distal of a heel pad of the foot.
(11) The device of (7)-(10) wherein the inflatable bladder configured to retain a minimum positive pressure throughout the periodic time cycle.
(12) The device of (11) wherein the minimum positive pressure is one of: i) at least 10 mmHg; ii) about 10 mmHg; or iii) from about 10 mmHg to about 15 mmHg.
(13) The device of (10) wherein the inflatable bladder is further configured to induce a bottom of the patient's foot to form a maximum angle with respect to the frame of about 30 degrees to about 45 degrees when the inflatable bladder is fully inflated.
(14) The device of (10) wherein the inflatable bladder is configured to induce dorsiflexion of the patient's foot of about 15 degrees to about 45 degrees.
(15) The device of (7)-(13) wherein the compression member comprises a compression wrap, disposable around a portion of the patient's foot and around a portion of the frame, configured to elastically move the foot toward the frame.
(17) The device of (1)-(16) wherein the foot support assembly is configured to position the patient's foot at about 5 degrees to about 10 degrees of plantar flexion in an at-rest position and induce periodic dorsiflexion in a fully flexed position of about 35 degrees to about 55 degrees relative to the at-rest position.
(18) The device of (16) wherein the foot support assembly is configured to include a substantially rigid frame having a foot support component coupled to an ankle support component, the substantially rigid frame configured to remain in a substantially undeflected position relative to the ankle support component throughout periodic urging of the patient's foot into dorsiflexion.
(19) The device of (7)-(18) further comprising a head unit comprising a compressed air tank, coupled to the inflatable bladder, configured to release compressed air to the inflatable bladder in periodic bursts having a duration of about 0.5 seconds.
(20) The device of (7)-(19) further comprising a head unit having a compressed air tank coupled to the inflatable bladder, the compressed air tank configured to operate at a tank pressure of about 20 psi to about 25 psi.
(21) The device of (1)-(20) wherein the device produces a reverse flow velocity index in a venous valve sinus of the patient during periods when the device is operated to induce dorsiflexion, the reverse flow velocity index being one of a) about −10 to about −30; b) about −10; c) about −20; or d) about −30.
(22) The device of (1)-(21) wherein the device produces a forward flow velocity index in a venous valve sinus of the patient during periods when the device is operated to induce dorsiflexion, the forward flow velocity index being one of a) about +10 to about +30; b) about +10; c) about +20; or d) about +30.
(23) The device of (1)-(22) wherein the device produces a forward flow velocity index in a venous valve sinus of the patient and a simultaneous reverse flow velocity index in the venous valve sinus of the patient during periods when the device is operated to induce dorsiflexion.
(27) The device of (7) further comprising a high ankle securement configured to secure the frame to the patient's leg at a high ankle of the patient at about 3 inches to about 7 inches above a bottom of the patient's foot.
(39) A system for stretching a calf muscle and inducing a calf muscle stretch reflex in an immobile person comprising, a wearable boot comprising an inflation bladder and configured to flex a top region of the foot of the immobile person when inflated to a set pressure during an inflation cycle, a head unit coupled to the inflation bladder and configured to provide compressed air to the inflation bladder to a set pressure, a pressure sensor configured to detect the internal pressure of the inflation bladder, and a processor that can cause the head unit to provide compressed air to the inflation bladder, monitor the internal pressure of the inflation bladder, and control one or more parameters of inflation; and wherein the inflation occurs in a time interval of about 0.25 seconds to about 0.5 seconds, wherein the rapid flexion induces a calf muscle stretch reflex thereby generating calf muscular contraction in the immobile person.
(40) A system for providing therapeutic stretch in an immobile person comprising, a wearable boot comprising an inflation bladder and configured to flex a top region of the foot of the immobile person when inflated to a set pressure during an inflation cycle, a head unit coupled to the inflation bladder and configured to provide compressed air to the inflation bladder to a set pressure, a pressure sensor configured to detect the internal pressure of the inflation bladder, and a processor that can cause the head unit to provide compressed air to the inflation bladder, monitor the internal pressure of the inflation bladder, and control one or more parameters of inflation; and wherein the inflation occurs in a time interval of about 1 second to about 30 seconds, wherein the slow flexion provides therapeutic stretch without inducing a calf muscle stretch reflex.
(41) A method of providing therapeutic dorsiflexion to an immobile person, the method comprising placing the foot of an immobile person in a wearable boot comprising an inflation bladder disposed between the boot and the foot of the immobile person, wherein the inflation bladder is configured to flex a top region of the foot about 15° to about 45° dorsally when the inflation bladder is inflated to a set pressure, using a head unit configured to provide compressed air to the inflation bladder to a set pressure, comprising at least one pressure sensor configured to detect the internal pressure of the inflation bladder, and monitoring the internal peak pressure of the inflation bladder to determine the ankle range of motion (ROM) of the immobile person.

In certain embodiments, the presently disclosed subject matter can provide a method of preventing ankle contracture by inducing dorsal flexion of a foot. In certain embodiments, the presently disclosed subject matter can provide a method of preventing calf muscle atrophy. The method can include securing the foot of an immobile patient to a frame, positioning a bladder between a bottom of the foot and the frame, and inflating the bladder to cause dorsal flexion of the foot against the frame. The frame can be a substantially rigid frame and can be configured to position the foot at about 5 degrees to about 10 degrees of plantar flexion in an at-rest position and induce periodic dorsiflexion in a fully flexed position of about 25 degrees to about 55 degrees relative to the at-rest position. In an embodiment, the bladder is wedge shaped, and can be inflated to cause dorsal flexion of the foot in time intervals ranging from about 0.25 seconds to about 0.5 seconds. In another embodiment, the bladder can be inflated to cause dorsal flexion of the foot in time intervals ranging from about 3 seconds to about 10 seconds. The method can include monitoring an air pressure within the bladder via an air pressure monitor. In an embodiment, causing dorsal flexion of the foot relative to the frame can induce venous oscillatory flow in a leg and the foot of the immobile patient. The method can include deflating the bladder to return the foot to a plantar flexion position. Deflating the bladder can include retaining a threshold positive pressure in the deflated bladder. The method can include a predetermine therapeutic duration of device activity and frequencies of device activity over a day. In some embodiments the device provides 10-15 minutes of therapy 5-10 times per day. In some embodiments the device provides at least 500 ankle dorsiflexions per day. In some embodiments the activity of the device is limited to a 12 hour window during the day to not disrupt patient sleeping or rest.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 15%, up to 10%, up to 5%, or up to 1% of a given value. Alternatively, particularly with respect to biological systems or processes, the term can mean an order of magnitude, preferably within five-fold, and more preferably within two-fold, of a value.

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, methods, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, and methods.

Patents, patent applications publications product descriptions, and protocols are cited throughout this application the disclosures of which are incorporated herein by reference in their entireties for all purposes.

1. A system for providing therapeutic foot dorsiflexion in an immobile person, comprising:
a) at least one wearable boot comprising a substantially rigid frame and an inflation bladder disposed therein, wherein the wearable boot is configured to admit a foot of the immobile person and to flex a top region of the foot about 15° to about 40° dorsally when the inflation bladder is inflated during an inflation cycle;
b) a head unit, coupled to the inflation bladder and configured to provide compressed air to the inflation bladder;
c) at least one pressure sensor, coupled to the inflation bladder and configured to detect an internal pressure of the inflation bladder; and
d) a processor arrangement communicatively coupled to at least one pressure sensor and to the head unit; and wherein the processor arrangement is configured to detect a peak internal pressure of the inflation bladder during an inflation cycle and to control the head unit to fill the inflation bladder to a set pressure during an inflation cycle.

2. The system of claim 1, wherein the processor arrangement is communicatively coupled to a non-transitory memory and the non-transitory memory stores instructions to:
i) cause the head unit to provide the compressed air to the inflation bladder;
ii) monitor the internal pressure of the inflation bladder sensed by the at least one pressure sensor during an inflation cycle, and control the set pressure of the inflation bladder during an inflation cycle.

3. The system of claim 2, wherein the non-transitory memory stores instructions to initiate a calibration cycle, wherein the calibration cycle comprises an inflation, hold, and deflation cycle, and wherein the processor arrangement monitors the peak internal pressure of the inflation bladder during the calibration cycle.

4. The system of claim 1, wherein the set pressure of the inflation bladder is determined by monitoring the peak internal pressure of the inflation bladder during a calibration cycle, wherein the calibration cycle comprises an inflation, hold, and deflation cycle, and wherein the processor arrangement monitors the peak internal pressure of the inflation bladder during the calibration cycle.

5. The system of claim 1, wherein the pressure of inflation bladder controls the degree of dorsiflexion, and wherein the set pressure of the inflation bladder is determined from one or more calibration cycles.

6. The system of claim 1, wherein an internal algorithm within the processor arrangement:
a) initiates a calibration cycle;
b) determines the peak internal bladder pressure; and
c) adjusts the set pressure of the inflation bladder during an inflation cycle, thereby controlling the degree of dorsiflexion.

7. The system of claim 1, wherein the set pressure of the inflation bladder is about 3 psi to about 20 psi.

8. The system of claim 1, wherein the head unit further comprises an a) air compressor, b) a compressed air tank, c) an air tank pressure sensor, configured to detect the pressure of the compressed air tank, and d) a valve, adapted to regulate the release of air from the compressed air tank to the inflation bladder through the opening of the valve, and wherein the processor arrangement is communicatively coupled to a) the air compressor, b) the compressed air tank, c) the air tank pressure sensor, and d) the valve.

9. The system of claim 8, wherein the processor arrangement is configured to:
i) fill the compressed air tank to a set pressure, by regulating the duration of air compressor activity; and
ii) open the valve for a set time.

10. The system of claim 9, wherein the set pressure of the air tank is about 5 psi to about 25 psi.

11. The system of claim 9, wherein an internal algorithm within the processor arrangement:
a) initiates a calibration cycle;
b) determines the peak internal bladder pressure during the calibration cycle;
d) refills the air tank to a set pressure; and
e) opens the valve for a set time during an inflation cycle.

12. The system of claim 11, wherein the set air tank pressure and valve opening time are determined by monitoring the peak internal pressure of the inflation bladder during a calibration cycle.

13. The system of claim 1, wherein the rigid frame is substantially covered in fabric, foam, gel padding, or air-filled padding which is configured to secure the foot of the immobile person within the boot while allowing the foot to flex dorsally.

14. The system of claim 1, wherein the inflation occurs in a time interval of about 0.25 seconds to about 0.5 seconds during an inflation cycle, and the rapid flexion induced by the system triggers a calf muscle contraction through a spinal reflex.

15. The system of claim 14, wherein the calf muscle contraction produces an electromyograph reading (EMG) of at least about 0.5 mV.

16. The system of claim 1, wherein the inflation occurs in a time interval of about 3 seconds to about 10 seconds during an inflation cycle and the slow flexion provides therapeutic stretch without inducing a calf muscle reflex.

17. The system of claim 1, wherein the head unit comprises
a) a control board, adapted to initiate inflation of the inflation bladder and control parameters of inflation;
b) a solenoid valve, adapted to regulate the release of the compressed air from the compressed air tank to the inflation bladder through the opening of the valve for a set time;
c) at least one pressure sensor, adapted to monitor air pressure of the compressed air tank and restore the air pressure to a set level; and
d) at least one pressure sensor, adapted to monitor air pressure within the inflation bladder.

18. The system of claim 17, wherein an algorithm in the control board monitors the internal pressure of the inflation bladder and modifies the set level of air pressure in the compressed air tank.

19. A method of providing therapeutic dorsiflexion to an immobile person, the method comprising:
a) placing the foot of an immobile person in a wearable boot comprising an inflation bladder disposed between the boot and the foot of the immobile person, wherein the inflation bladder is configured flex a top region of the foot about 15° to about 45° dorsally when the inflation bladder is inflated;
b) determining the patient's maximum ankle range of motion (ROM) by monitoring the peak internal pressure of the inflation bladder during a first inflation calibration cycle; and
c) adjusting the bladder inflation pressure during a second therapeutic inflation cycle.

20. A method of providing therapeutic stretch therapy to an immobile person, the method comprising:
a) placing the foot of an immobile person in a wearable boot comprising an inflation bladder disposed between the boot and the foot of the immobile person, wherein the inflation bladder is configured flex a top region of the foot about 15° to about 45° dorsally when the inflation bladder is inflated;
b) determining the patient's maximum ankle range of motion (ROM) by monitoring the peak internal pressure of the inflation bladder during a first calibration cycle;
c) providing a therapeutic stretch therapy session comprising about 15 to about 30 subsequent inflation cycles; and
d) determining the patient's maximum ankle ROM motion after the therapeutic stretch therapy session by monitoring the peak internal pressure of the inflation bladder during a second calibration cycle.
